(19) United States
(12) Patent Application Publication
(10) Pub. No.: US 2020/0062660 A1
(43) Pub. Date: Feb. 27, 2020

(54) MULTI-STEP CURING OF GREEN BODIES

(71) Applicant: Solidia Technologies, Inc., Piscataway, NJ (US)

(72) Inventor: Ahmet Cuneyt Tas, Piscataway, NJ (US)

(21) Appl. No.: 16/552,642

(22) Filed: Aug. 27, 2019

Related U.S. Application Data
(60) Provisional application No. 62/723,397, filed on Aug. 27, 2018.

(51) Int. Cl. C04B 40/02; B28B 11/24; C04B 40/00; C04B 28/02

(52) U.S. Cl. CPC C04B 40/0236; B28B 11/245; C04B 2111/00077; C04B 40/0082; C04B 28/02; C04B 40/0039

(57) ABSTRACT

A method of forming a plurality of cured concrete bodies, each body possessing a cured compressive strength, the disclosed method includes: introducing a flowable mixture of constituent components of the concrete into a plurality of molds; molding the flowable mixture within the plurality of molds with the aid of one or more support, thereby forming a plurality of green bodies; partially curing the green bodies to a degree sufficient to provide a compressive strength that is lower than the cured compressive strength, thereby producing a plurality of pre-cured green bodies; assembling at least a portion of the plurality of pre-cured green bodies to form a collection thereof having a predetermined geometrical configuration; and curing the collection of pre-cured green bodies to a degree sufficient to achieve the cured compressive strength, thereby producing a collection of cured bodies having the predetermined geometrical configuration.

The present application claims priority to and the benefit of U.S. Provisional Application No. 62/723,397 filed Aug. 27, 2018, the entire contents of which is incorporated herein by reference.

### FIELD

The present application is directed to methods for the curing of objects, such as green bodies, associated devices and systems.

### BACKGROUND

In this specification where a document, act or item of knowledge is referred to or discussed, this reference or discussion is not an admission that the document, act or item of knowledge or any combination thereof was at the priority date, publicly available, known to the public, part of common general knowledge, or otherwise constitutes prior art under the applicable statutory provisions; or is known to be relevant to an attempt to solve any problem with which this specification is concerned.

The densification of uncured or partially cured “green bodies” can present a number of different technical challenges, especially when such processes are conducted on a large scale. Issues such as those related to efficiency, non-static processing conditions, consistency and reproducibility, may arise. The present invention seeks to address these, and other challenges.

One example of an uncured or “green body” that is subjected to a curing process is concrete or cement. Concrete, especially, is omnipresent. Our homes likely rest on it, our infrastructure is built from it, as are most of our workplaces. Conventional concrete is made by mixing water and aggregates such as sand and crushed stone with Portland cement, a synthetic material made by burning a mixture of ground limestone and clay, or materials of similar composition in a rotary kiln at a sintering temperature of around 1,450° C. Portland cement manufacturing is not only an energy-intensive process, but also one that releases considerable quantities of a greenhouse gas (CO₂). The cement industry accounts for approximately 5% of global anthropogenic CO₂ emissions. More than 60% of such CO₂ comes from the chemical decomposition or calcination of limestone. Conventional concrete production and use is not optimal in terms of both economics and environmental impact. Such conventional concrete production technologies involve large energy consumption and carbon dioxide emissions, leading to an unfavorable carbon footprint.

This has led to the development of non-hydraulic cement formulations. Non-hydraulic cement refers to a cement that is not cured by the consumption of water in a chemical reaction, but rather is primarily cured by reaction with carbon dioxide, CO₂, in any of its forms, such as, gaseous CO₂, CO₂ in the form of carbonic acid, H₂CO₃, or in other forms that permit the reaction of CO₂ with the non-hydraulic cement material. The curing process sequesters carbon dioxide gas in the form of solid carbonate species within the cured material, thus providing obvious environmental benefits. By way of example, non-hydraulic Solidia Cement™ and Solidia Concrete™ formulations have been heralded as breakthrough technologies, having been recognized, for example, as one of the top 100 new technologies by the R&D 100 awards. The production of both Solidia Cement™ and Solidia Concrete™ reduces carbon emissions up to 70%, reduces fuel consumption by 30%, and reduces water usage by up to 80%, when compared with the production of traditional hydraulic concrete and/or or Portland cement.

Conventional curing techniques and apparatus for many systems of materials, including conventional concrete as well as non-hydraulic concrete formulations, are configured to handle materials that undergo specific chemical reactions. However, in practice, the use of conventional techniques and apparatus for curing green bodies presents certain technical challenges. Problems that are associated with conventional curing techniques and apparatus include their cost, limitations regarding operating conditions and locations, the precision with which the curing process may be controlled and monitored in a consistent and repeatable manner, and the production of cured articles with adequate properties. Thus, a need exists for curing methods and apparatus that provide improved versatility, precision, yield, consistency and reduced costs.

As schematically illustrated in FIGS. 1-2, articles (10) formed from hydraulic cement or concrete compositions, as well as non-hydraulic cement or concrete compositions, e.g., concrete compositions containing calcium silicate, sand, and aggregate, such as pavers (of any dimensions) or blocks/slabs (again, of any dimensions) can be produced by using a press (20) as a forming/manufacturing method. More specifically, hollow molds (30) are located on a support (40) such as a steel (or plastic or any other material of sufficient strength) boards or flat trays. The concrete composition is then introduced into openings (50) in the molds (30). Optionally, the molds (30) are vibrated to promote optimal filling of the molds (30) with the concrete mix. Once filled, the press (20) compresses the concrete material within the molds (30). As a result, one or more green pressed bodies (10) are formed on the support (40). Subsequently, the pressed bodies (10), along with their supports (40), are subjected to a number of possible processing steps, such as drying, pre-curing, and ultimately, curing within a chamber (not shown) to generate strength. After curing, the bodies (e.g., pavers) are “palletized” by removing them from their supports (40) and stacking them, typically with the use of a machine, to form cubes of finished bodies or pavers resting on a support for shipping, such as a pallet. Each cube can have, e.g., about 540 (or more) pavers stacked in the format of 10 paver layers on top of one another while each layer containing 54 pavers. This is called a “paver cube.” Such paver cubes can then be delivered to the customer. Key steps (60) associated with the above-described process are schematically illustrated in FIG. 3. As illustrated therein, the constituent ingredients that make up the cement/concrete formulation are batched and mixed, introduced into molds where they are pressed thus forming one or more green bodies. The green bodies are then cured, and subsequently the fully cured bodies are stacked on a pallet for shipping to the purchaser.

According to current large-scale operations, the curing process extends for very long periods of time, such as about 50 to 80 h, or even longer. During such long curing times, the pavers remain on their supports or pressing boards. Occupying the pressing boards for 50 to 80 h is disadvantageous to the cost- and time-effectiveness of the entire process. Occupation of the pressing boards throughout the entire curing process places undesired stress on the pressing operations of the manufacturer's facilities, and requires the manufacturer to purchase more pressing boards than would ideally be the case.

Furthermore, pavers formed from non-hydraulic compositions, such as Solidia Cement and Solidia Concrete™, mentioned above, relies on a gaseous reactant, i.e., carbon dioxide (CO₂). Carbon dioxide acts a reactant only if the materials to be carbonation-cured contain a certain amount (e.g., 2 to 5% by weight) of water in them. Carbon dioxide gas is first dissolved in water, then transforms itself into aqueous bicarbonate or carbonate ions, which will then react with the aqueous Ca²⁺ ions originating from the non-hydraulic composition to form well-connected crystals/particles of calcium carbonate (CaCO₃). In other words, one cannot cure such compositions if the pavers are completely dry. Thus, curing of pavers formed from such non-hydraulic compositions involves water content control.

Another disadvantage of keeping pavers on pressing boards throughout the curing process is that the surfaces of the pavers in contact with the boards prevent or impede the release of water from the green body, and also prevents or impedes direct exposure to reactants within the curing chamber (e.g., CO₂ gas).

Thus, there is a need for improved curing techniques and apparatus that allows for the pressing boards to be retrieved/recovered and returned back to the press machine as soon as possible, as well as improving exposure of the bottom surfaces of the pressed bodies (e.g., pavers/objects) to reactant(s), and to facilitate the release of water therefrom.

While certain aspects of conventional technologies have been discussed to facilitate disclosure of the invention, Applicants in no way disclaim these technical aspects, and it is contemplated that the claimed invention may encompass or include one or more of the conventional technical aspects discussed herein.

### SUMMARY

It has been discovered that the above-noted deficiencies can be addressed, and certain advantages attained, by the present invention. For example, the methods, devices and systems of the present invention provide for the curing of green bodies that exhibit improved versatility, precision, yield, consistency and reduced cost.

In order to facilitate the description of the concepts of the present invention, the disclosure contained herein may refer to green and/or cured bodies as “pavers.” However, it should be understood that the principles of the present invention are not so limited. The principles described herein are applicable to any number of different bodies or objects, despite any particular references herein to “pavers.” For example, the process described in this disclosure can be used for the production of concrete products, wherein the concrete product is optionally made of a bonding matrix that hardens when exposed to carbon dioxide. In some embodiments, the concrete products are foamed concrete objects. In some embodiments the concrete products are aerated concrete objects. In some embodiments the aerated concrete objects are aerated blocks and/or aerated masonry units. In some embodiments the foamed concrete objects are aerated panels. In some embodiments the aerated panels have optional structural reinforcement in them in the form of rebar. In other embodiments, the concrete products are precast concrete objects such as roof tiles, concrete blocks, concrete slabs, wet cast slabs and hollow core slabs.

Certain features of the present invention will now be described. It should be understood that the present invention encompasses any of the forgoing features used individually, or in combination with any other feature (or features) described in the following paragraphs or otherwise described herein, without limitation on the particular combinations thereof. Thus, for example, it is comprehended that the present invention encompasses any possible combination of the claims contained herein, regardless of their current dependencies.

According to one aspect, the present invention provides a method of forming a plurality of cured concrete bodies, each body possessing a cured compressive strength, the method comprising: introducing a flowable mixture of constituent components of the concrete into a plurality of molds; molding the flowable mixture within the plurality of molds with the aid of one or more support, thereby forming a plurality of green bodies; partially curing the green bodies to a degree sufficient to provide a compressive strength that is lower than the cured compressive strength, thereby producing a plurality of pre-cured green bodies; assembling at least a portion of the plurality of pre-cured green bodies to form a collection thereof having a predetermined geometrical configuration; and curing the collection of pre-cured green bodies to a degree sufficient to achieve the cured compressive strength, thereby producing a collection of cured bodies having the predetermined geometrical configuration.

The method further comprising: causing the collection of cured bodies having the predetermined geometrical configuration to be shipped to a customer.

The method wherein the constituent components comprise one or more carbonatable cement component and one or more aggregate.

The method wherein the one or more carbonatable cement component comprises calcium silicate.

The method wherein the flowable mixture comprises water.

The method wherein at least one of the steps of introducing and molding comprises one or more of: pouring, vibrocasting, pressing, extruding, or foaming.

The method wherein the one or more support is a pressing board.

The method wherein the one or more support is metallic.

The method wherein the plurality of green bodies comprise pavers, concrete blocks, roof tiles, hollow core slabs, wet cast slabs, concrete slabs, foamed concrete bodies, aerated concrete bodies, aerated concrete masonry units, or aerated concrete panels.

The method wherein the compressive strength of the pre-cured green bodies is sufficient to permit removal of the green bodies from the support, while the green bodies remain substantially intact.

The method wherein the compressive strength of the pre-cured green bodies is about 2,000 psi to about 5,000 psi, as measured according to ASTM C140.

The method wherein the cured compressive strength is at least about 8,000 psi, as measured according to ASTM C140.

The method wherein the step of partially curing the green bodies comprises introducing the green bodies and the one or more support into a pre-curing chamber.

The method wherein the step of partially curing the green bodies comprises exposing the green bodies and the one or more support to carbon dioxide, air, or a combination thereof, for a predetermined period of time.

The method wherein the step of partially curing the green bodies comprises exposing the green bodies to carbon dioxide for a period of time of about 60 to about 600 minutes, and a temperature of about 50° C. to about 120° C.

The method of wherein the step of partially curing the green bodies further comprising heating the at least one metallic support.

The method of wherein the heating of the at least one metallic support comprises electrical resistance heating.

The method wherein the step of assembling the plurality of pre-cured green bodies comprising removing the pre-cured green bodies from a surface of the one or more support.

The method wherein the pre-cured green bodies are removed from the one or more support using a palletizer machine or a material handling system.

The method wherein the predetermined geometrical configuration is a cube.

The method wherein the cube comprises about 480 pre-cured green bodies, or more.

The method wherein the step of curing the pre-cured green bodies comprises introducing the collection of pre-cured green bodies into a curing chamber.

The method wherein the step of curing the pre-cured green bodies comprises exposing the pre-cured green bodies to carbon dioxide for a period of time of about 10 to about 24 hours, and a temperature of about 60° C. to about 95° C.

The method wherein the step of partially curing the green bodies, or the step of curing the pre-cured green bodies, further comprising introducing heated gas into the pre-curing or curing chamber from a location disposed proximate to the bottom of the pre-curing or curing chamber.

The method wherein the step of partially curing the green bodies, or the step of curing the pre-cured green bodies, further comprising withdrawing the heated gas from the pre-curing or curing chamber from a location disposed proximate to the top of the pre-curing or curing chamber.

The method wherein the step of curing the pre-cured green bodies further comprises placing the collection of pre-cured green bodies onto a moveable platform for moving the collection of pre-cured green bodies from one end of the curing chamber to an opposite end.

The method wherein the green bodies and their supports have a sample volume, and the pre-curing chamber has an interior volume, and wherein a ratio of the interior volume of the pre-curing chamber to the sample volume is about 1.05 to about 1.15.

The method wherein the collection of pre-cured green bodies having the predetermined geometrical configuration has a sample volume, and the curing chamber has an interior volume, and wherein a ratio of the interior volume of the curing chamber to the sample volume is about 1.05 to about 1.15.

### BRIEF DESCRIPTION OF THE DRAWINGS

FIG. 1 is a schematic illustration of an arrangement and the technique for forming one or more green body from a flowable mixture.

FIG. 2 is a schematic illustration of one or more green body resulting from the technique and arrangement of FIG. 1, disposed upon a surface of a support.

FIG. 3 is a flow diagram of a conventional procedure for forming cured concrete bodies.

FIG. 4 is a schematic illustration of an arrangement and technique for curing one or more green body

FIG. 5 is a schematic illustration of a technique and curing chamber design according to certain optional aspects of the present invention.

FIG. 6 is a schematic illustration of a collection of green bodies forming a particular geometrical configuration, and an optional platform.

FIG. 7 is a schematic illustration of a technique and curing chamber design according to further optional aspects of the present invention.

FIG. 8 is a schematic illustration of a technique and curing chamber design according to additional optional aspects of the present invention.

FIG. 9 is a schematic illustration of a technique and curing chamber design according to still further optional aspects of the present invention

### DETAILED DESCRIPTION

As used herein, the term “green body” refers to an uncured or partially cured body or object. In certain optional embodiments, the green body is in the form of a cement or concrete (composite) body.

“Carbonatable,” as used herein, refers to a material that is reactive with CO₂ via a carbonation reaction. A material is “uncarbonatable” if it is unreactive with CO₂ via a carbonation reaction under conditions disclosed herein. According to certain embodiments, the carbonatable material can take the form of a cement or concrete (composite).

As used herein, “flowable mixture” is a mixture that can be shaped or otherwise formed into a green body having a desired geometrical shape and dimensions.

As used herein, “substantially intact” means retaining, for the most part, the overall shape and configuration of a body or object. The term does not prohibit relatively minor breakage or crumbling of the body, so long as its overall shape and configuration is retained.

As used herein, the singular forms “a”, “an” and “the” are intended to include the plural forms as well, unless the context clearly indicates otherwise. Additionally, the use of “or” is intended to include “and/or”, unless the context clearly indicates otherwise.

As used herein, “about” is a term of approximation and is intended to include minor variations in the literally stated amounts, as would be understood by those skilled in the art. Such variations include, for example, standard deviations associated with techniques commonly used to measure the amounts of the constituent elements or components of a composite material, or other properties and characteristics. All of the values characterized by the above-described modifier “about” are also intended to include the exact numerical values disclosed herein. Moreover, all ranges include the upper and lower limits, and all values within those limits.

Any compositions described herein are intended to encompass compositions which consist of, consist essentially of, as well as comprise, the various constituents identified herein, unless explicitly indicated to the contrary.

Certain abbreviations used herein have the following meaning:

ER=early retrieval (early removal) of the paver pressing boards;

PCC=paver cube curing;

VBUF=vertical bottom up flow;

CV=chamber volume (for both pre-curing and curing); and

SV=sample volume (sample can be bodies or pavers on their pressing boards or can be bodies or pavers stacked and packed tightly with one another to form a particular geometrical configuration, such as a discrete cube or rectangular prism, to cure, with or without an optional platform);

CC=continuous curing of individual pavers entering a chamber from one side, where the pavers can be placed by a material handling system on a moving (continuously or intermittently) conveyor, and exiting from the other side of the same chamber.

### Forming a Flowable Mixture—Green Body Composition and Morphology

It is envisioned that the principles of the present invention can find application to a number of different chemical compositions and morphologies, and is not necessarily limited thereby. Thus, the following discussion is intended to be representative of suitable, yet nonlimiting, examples of green body chemistries and morphologies.

According to certain aspects, curable green bodies suitable for the curing methods, devices and systems of the present invention can be formed from a carbonatable material.

According to further optional aspects, curable green bodies suitable for the curing methods, devices and systems of the present invention can be formed from a calcium silicate and/or magnesium silicate and/or magnesium hydroxide material.

The term “calcium silicate” material, as used herein, generally refers to naturally-occurring minerals or synthetic materials that are comprised of one or more of a groups of calcium silicate phases. Exemplary carbonatable calcium silicate phases include CS (wollastonite or pseudowollastonite, and sometimes formulated CaSiO₃ or CaO·SiO₂), C3S2 (rankinite, and sometimes formulated as Ca₃Si₂O₇ or 3CaO·2SiO₂), C2S (belite, β-Ca₂O₄ or larnite, Ca₇Mg(SiO₄)₄ or bredigite, α-Ca₂SiO₄ or γ-Ca₂SiO₄, and sometimes formulated as Ca₂SiO₄ or 2CaO·SiO₂). Amorphous phases can also be carbonatable depending on their composition. Each of these materials may include one or more other metal ions and oxides (e.g., aluminum, magnesium, iron or manganese oxides), or blends thereof, or may include an amount of magnesium silicate in naturally-occurring or synthetic form(s) ranging from trace amount (1%) to about 50% or more by weight. Exemplary uncarbonatable or inert phases include gehlenite/melilite ((Ca,Na,K)₂[(Mg, Fe²⁺,Fe³⁺, Al,Si)₃O₇]) and crystalline silica (SiO₂). The carbonatable calcium silicate phases included in the calcium silicate composition do not hydrate extensively when exposed to water. Due to this, composites produced using a calcium silicate composition as the binding agent do not generate significant strength when combined with water. The strength generation is controlled by exposure of calcium silicate composition containing composites to specific curing regimes in the presence of CO₂.

As used herein, the term “magnesium silicate” refers to naturally-occurring minerals or synthetic materials that are comprised of one or more of a groups of magnesium-silicon-containing compounds including, for example, Mg₂SiO₄ (also known as “forsterite”) and Mg₃Si₄O₁₀(OH)₂ (also known as “talc”) and CaMgSiO₄ (also known as “monticellite”), each of which material may include one or more other metal ions and oxides (e.g., calcium, aluminum, iron or manganese oxides), or blends thereof, or may include an amount of calcium silicate in naturally-occurring or synthetic form(s) ranging from trace amount (1%) to about 50% or more by weight.

In exemplary embodiments, ground calcium silicate is used. The ground calcium silicate may have a mean particle size from about 1 μm to about 100 μm (e.g., about 1 μm to about 80 μm, about 1 μm to about 60 μm, about 1 μm to about 50 μm, about 1 μm to about 40 μm, about 1 μm to about 30 μm, about 1 μm to about 20 μm, about 1 μm to about 10 μm, about 1 μm to about 5 μm, about 5 μm to about 90 μm, about 5 μm to about 80 μm, about 5 μm to about 70 μm, about 5 μm to about 60 μm, about 5 μm to about 50 μm, about 5 μm to about 40 μm, about 10 μm to about 80 μm, about 10 μm to about 70 μm, about 10 μm to about 60 μm, about 10 μm to about 50 μm, about 10 μm to about 40 μm, about 10 μm to about 30 μm, about 10 μm to about 20 μm, about 1 μm, 10 μm, 15 μm, 20 μm, 25 μm, 30 μm, 40 μm, 50 μm, 60 μm, 70 μm, 80 μm, 90 μm, or 100 μm).

The ground calcium silicate may have a bulk density of about 0.5 g/mL to about 3.5 g/mL (e.g., 0.5 g/mL, 1.0 g/mL, 1.5 g/mL, 2.0 g/mL, 2.5 g/mL, 2.8 g/mL, 3.0 g/mL, or 3.5 g/mL) and a tapped density of about 1.0 g/mL to about 1.2 g/mL.

The ground calcium silicate may have a Blaine surface area from about 150 m²/kg to about 700 m²/kg (e.g., 150 m²/kg, 200 m²/kg, 250 m²/kg, 300 m²/kg, 350 m²/kg, 400 m²/kg, 450 m²/kg, 500 m²/kg, 550 m²/kg, 600 m²/kg, 650 m²/kg, or 700 m²/kg).

In exemplary embodiments of the calcium silicate composition, ground calcium silicate particles used have a particle size having a cumulative 10% diameter greater than 1 μm in the volume distribution of the particle size distribution.

Any suitable aggregates may be used to form composite materials from the carbonatable composition of the invention, for example, calcium oxide-containing or silica-containing materials. Exemplary aggregates include inert materials such as trap rock, construction sand, pea-gravel. In certain preferred embodiments, lightweight aggregates such as perlite or vermiculite may also be used as aggregates. Materials such as industrial waste materials (e.g., fly ash, slag, silica fume) may also be used as fine fillers.

The plurality of aggregates may have any suitable mean particle size and size distribution. In certain embodiments, the plurality of aggregates has a mean particle size in the range from about 0.25 mm to about 25 mm (e.g., about 5 mm to about 20 mm, about 5 mm to about 18 mm, about 5 mm to about 15 mm, about 5 mm to about 12 mm, about 7 mm to about 20 mm, about 10 mm to about 20 mm, about ⅛″, about ¼″, about ⅜″, about ½″, about ¾″).

Chemical admixtures may also be included in the composite material; for example, plasticizers, retarders, accelerators, dispersants and other rheology-modifying agents. Certain commercially available chemical admixtures such as Glenium™ 7500 by BASF® Chemicals, HC-300 by SIKA, and Acumer™ by Dow Chemical Company may also be included. In certain embodiments, one or more pigments may be evenly dispersed or substantially unevenly dispersed in the bonding matrices, depending on the desired composite material. The pigment may be any suitable pigment including, for example, oxides of various metals (e.g., black iron oxide, cobalt oxide and chromium oxide). The pigment may be of any color or colors, for example, selected from black, white, blue, gray, pink, green, red, yellow and brown. The pigment may be present in any suitable amount depending on the desired composite material, for example in an amount ranging from about 0.0% to about 10% by weight.

A major advantage of the carbonatable composition is that it can be carbonated to form composite materials that are useful in a variety of application.

The following reactions are believed to take place during carbonation of calcium silicate as disclosed herein.

CaSiO₃(s)+CO₂(g)→CaCO₃(s)+SiO₂(s) (1)

Ca₃Si₂O₇(s)+3CO₂(g)→3CaCO₃(s)+2SiO₂(s) (2)

Ca₂SiO₄(s)+2CO₂(g)→2CaCO₃(s)+SiO₂(s) (3)

Generally, CO₂ is introduced as a gas phase that dissolves into an infiltration medium, such as water. The dissolution of CO₂ forms acidic carbonic species (such as carbonic acid, H₂CO₃) that results in a decrease of pH in solution. The weakly acidic solution incongruently dissolves calcium species from the calcium silicate phases, then the carbonic acid transforms into aqueous carbonate ions. Calcium may be leached from calcium containing amorphous phases through a similar mechanism. The released calcium cations and the aqueous carbonate species (such as HCO₃⁻, CO₃²⁻ and Ca(HCO₃)₂) lead to the precipitation of insoluble solid carbonates. Silica-rich layers, which were abbreviated in equations (1) through (3) as SiO₂ (s), are thought to remain on the mineral particles.

The CaCO₃ produced from these or any other CO₂ carbonation reactions disclosed herein may exist as one or more of several CaCO₃ polymorphs (e.g., calcite, aragonite, and vaterite). The CaCO₃ particles are preferably in the form of calcite but may also be present as aragonite or vaterite or as a combination of two or three of the polymorphs (e.g., calcite/aragonite, calcite/vaterite, aragonite/vaterite or calcite/aragonite/vaterite).

Any suitable grade of CO₂ may be used depending on the desired outcome of carbonation. For example, industrial grade CO₂ at about 99% purity may be used, which is commercially available from a variety of different industrial gas companies, such as Praxair, Inc., Linde AG, Air Liquide, and others. The CO₂ supply may be held in large pressurized holding tanks in the form of liquid carbon dioxide regulated at a temperature such that it maintains a desired vapor pressure, for example, of approximately 300 PSIG. This gas is then piped to a CO₂ curing (carbonation) enclosure or chamber. In the simplest system, CO₂ is flowed through the enclosure at a controlled rate sufficient to displace the ambient air in the enclosure. In general, the purge time will depend on the size of the chamber or enclosure and the rate that CO₂ gas is provided. In many systems, this process of purging of air can be performed in times measured in minutes to get the CO₂ concentration up to a reasonable level so that curing can be performed thereafter. In simple systems, CO₂ gas is then fed into the system at a predefined rate so to maintain a concentration of CO₂ sufficient to drive the curing reaction.

The carbonation, for example, may be carried out reacting it with CO₂ via a controlled Hydrothermal Liquid Phase Sintering (HLPS) process to create bonding elements that hold together the various components of the composite material. For example, in preferred embodiments, CO₂ is used as a reactive species resulting in sequestration of CO₂ and the creation of bonding elements in the produced composite materials with in a carbon footprint unmatched by any existing production technology. The HLPS process is thermodynamically driven by the free energy of the chemical reaction(s) and reduction of surface energy (area) caused by crystal growth. The kinetics of the HLPS process proceed at a reasonable rate at low temperature because a solution (aqueous or nonaqueous) is used to transport reactive species instead of using a high melting point fluid or high temperature solid-state medium.

Collectively, the bonding elements form an inter-connected bonding matrix creating bonding strength and holding the composite material together. For example, the microstructured bonding elements may be: a bonding element comprising a core of an unreacted carbonatable phase of calcium silicate fully or partially surrounded by a silica rich rim of varying thickness that is fully or partially encased by CaCO₃ particles; a bonding element comprising a core of silica formed by carbonation of a carbonatable phase of calcium silicate fully or partially surrounded by a silica rich rim of varying thickness that is fully or partially encased by CaCO₃ particles; a bonding element comprising a core of silica formed by carbonation of a carbonatable phase of calcium silicate and fully or partially encased by CaCO₃ particles; a bonding element comprising a core of an uncarbonatable phase fully or partially encased by CaCO₃ particles; a bonding element comprising a multi-phase core comprised of silica formed by carbonation of a carbonatable phase of calcium silicate and partially reacted calcium silicate, which multi-phase core is fully or partially surrounded by a silica rich rim of varying thickness that is fully or partially encased by CaCO₃ particles; a bonding element comprising a multi-phase core comprised of an uncarbonatable phase and partially reacted calcium silicate, which multi-phase core is fully or partially surrounded by a silica rich rim of varying thickness that is fully or partially encased by CaCO₃ particles; a bonding element comprising particles of partially reacted calcium silicate without a distinct core and silica rim encased by CaCO₃ particles; and a bonding element comprising porous particles without a distinct silica rim encased by CaCO₃ particles.

The silica rich rim generally displays a varying thickness within a bonding element and from bonding element to bonding element, typically ranging from about 0.01 μm to about 50 μm. In certain preferred embodiments, the silica rich rim has a thickness ranging from about 1 μm to about 25 μm. As used herein, “silica rich” generally refers to a silica content that is significant among the components of a material, for example, silica being greater than about 50% by volume. The remainder of the silica rich rim is comprised largely of CaCO₃, for example 10% to about 50% of CaCO₃ by volume. The silica rich rim may also include inert or unreacted particles, for example 10% to about 50% of melilite by volume. A silica rich rim generally displays a transition from being primarily silica to being primarily CaCO₃. The silica and CaCO₃ may be present as intermixed or discrete areas.

The silica rich rim is also characterized by a varying silica content from bonding element to bonding element, typically ranging from about 50% to about 90% by volume (e.g., from about 60% to about 80%). In certain embodiments, the silica rich rim is generally characterized by a silica content ranging from about 50% to about 90% by volume and a CaCO₃content ranging from about 10% to about 50% by volume. In certain embodiments, the silica rich rim is characterized by a silica content ranging from about 70% to about 90% by volume and a CaCO₃ content ranging from about 10% to about 30% by volume. In certain embodiments, the silica rich rim is characterized by a silica content ranging from about 50% to about 70% by volume and a CaCO₃ content ranging from about 30% to about 50% by volume.

The silica rich rim may surround the core to various degrees of coverage anywhere from about 1% to about 99% (e.g., about 10% to about 90%). In certain embodiments, the silica rich rim surrounds the core with a degree of coverage less than about 10%. In certain embodiments, the silica rich rim of varying thickness surrounds the core with a degree of coverage greater than about 90%.

A bonding element may exhibit any size and any regular or irregular, solid or hollow morphology, which may be favored one way or another by raw materials selection and the production process in view of the intended application. Exemplary morphologies include: cubes, cuboids, prisms, discs, pyramids, polyhedrons or multifaceted particles, cylinders, spheres, cones, rings, tubes, crescents, needles, fibers, filaments, flakes, spheres, sub-spheres, beads, grapes, granules, oblongs, rods, ripples, etc.

The plurality of bonding elements may have any suitable mean particle size and size distribution dependent on the desired properties and performance characteristics of the composite product. In certain embodiments, for example, the plurality of bonding elements have a mean particle size in the range of about 1 μm to about 100 μm (e.g., about 1 μm to about 80 μm, about 1 μm to about 60 μm, about 1 μm to about 50 μm, about 1 μm to about 40 μm, about 1 μm to about 30 μm, about 1 μm to about 20 μm, about 1 μm to about 10 μm, about 5 μm to about 90 μm, about 5 μm to about 80 μm, about 5 μm to about 70 μm, about 5 μm to about 60 μm, about 5 μm to about 50 μm, about 5 μm to about 40 μm, about 10 μm to about 80 μm, about 10 μm to about 70 μm, about 10 μm to about 60 μm, about 10 μm to about 50 μm, about 10 μm to about 40 μm, about 10 μm to about 30 μm, or about 10 μm to about 20 μm).

The inter-connected network of bonding elements (a bonding matrix) may also include a plurality of coarse or fine filler particles that may be of any suitable material, have any suitable particle size and size distribution. In certain preferred embodiments, for example, the filler particles are made from a calcium carbonate-rich material such as limestone (e.g., ground limestone). In certain materials, the filler particles are made from one or more of SiO₂-based or silicate-based material such as quartz, mica, granite, and feldspar (e.g., ground quartz, ground mica, ground granite, ground feldspar).

In certain embodiments, filler particles may include natural, synthetic and recycled materials such as glass, recycled glass, coal slag, fly ash, calcium carbonate-rich material and magnesium carbonate-rich material.

In certain embodiments, the plurality of filler particles has a mean particle size in the range from about 5 μm to about 7 mm (e.g., about 5 μm to about 5 mm, about 5 μm to about 4 mm, about 5 μm to about 3 mm, about 5 μm to about 2 mm, about 5 μm to about 1 mm, about 5 μm to about 500 μm, about 5 μm to about 300 μm, about 20 μm to about 5 mm, about 20 μm to about 4 mm, about 20 μm to about 3 mm, about 20 μm to about 2 mm, about 20 μm to about 1 mm, about 20 μm to about 500 μm, about 20 μm to about 300 μm, about 100 μm to about 5 mm, about 100 μm to about 4 mm, about 100 μm to about 3 mm, about 100 μm to about 2 mm, or about 100 μm to about 1 mm).

The weight ratio of bonding elements to filler particles may be any suitable ratios dependent on the intended application for the composite material product. For example, the weight ratio of bonding elements to filler particles may be in the range from about (50 to 99): about (1 to 50), e.g., from about (60 to 99): about (1 to 40), from about (80 to 99): about (1 to 20), from about (90 to 99): about (1 to 10), from about (50 to 90): about (10 to 50), or from about (50 to 70): about (30 to 50). In certain embodiments depending on the application, the weight ratio of bonding elements to filler particles may be in the range from about (10 to 50): about (50 to 90), e.g., from about (30 to 50): about (50 to 70), from about (40 to 50): about (50 to 60).

A green body suitable for curing according to the principles of the present invention typically possess significant porosity. When the green body is formed from a carbonatable material, CO₂ needs to diffuse throughout the green body so that it can react with the chemical composition of the green body at all depths and to an extent sufficient to create desirable physical and chemical properties within the carbonated article. Since the diffusion of CO₂ gas is significantly faster than diffusion of CO₂ dissolved in water or any of its associated aqueous species, it is desirable for the pores of the green body to be “open” in order to facilitate the diffusion of gaseous CO₂ therethrough. On the other hand, the presence of water may be needed to facilitate the carbonation reaction. For example, with respect to the exemplary calcium silicate material, as described herein, the dissolution of CO₂ forms acidic carbonic species (such as carbonic acid, H₂CO₃) that results in a decrease of pH in solution. The weakly acidic solution incongruently dissolves calcium species from the calcium silicate phases. The released calcium cations and the dissociated carbonate species can lead to the formation of the above-described bonding elements. The amount of water contained in the green bodies selected so as to provide the appropriate diffusion of carbon dioxide gas, as noted above. For example, according to certain nonlimiting embodiments, the green body may possess a water content of 2%-5%, by weight.

### Forming the Flowable Mixture Into One or More Green Body

A flowable mixture as described herein can be shaped or otherwise formed into one or more green body having a desired geometrical shape and dimensions. There are no particular limitations on suitable shapes or sizes of the green bodies. Thus, for example, the green bodies can be provided in the form of pavers, concrete blocks, roof tiles, hollow core slabs, wet cast slabs, concrete slabs, foamed concrete bodies, aerated concrete bodies, aerated concrete masonry units, or aerated concrete panels, to name a few examples.

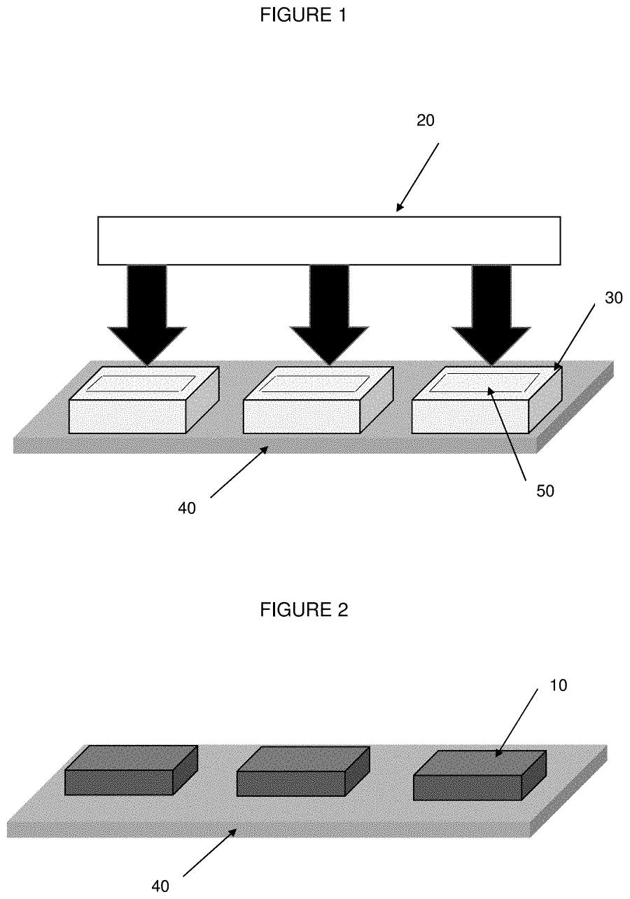

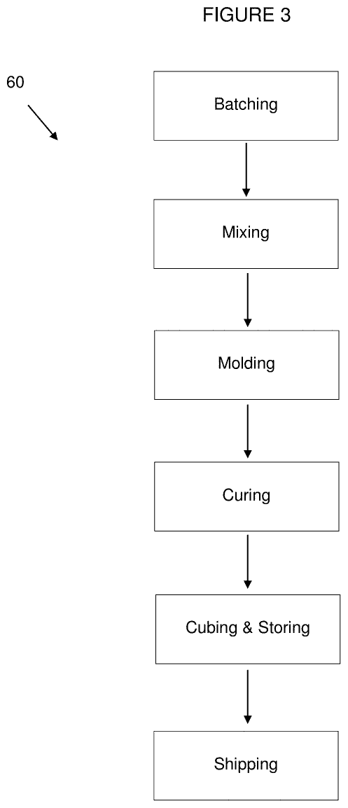

Likewise, the particular process or technique of forming the flowable mixture into a green body having the desired geometrical shape and dimensions is not particularly limited. Any conventional forming technique can be utilized, and is envisioned as being comprehended by the scope of the present invention. Suitable forming techniques include, but are not limited to, pouring, molding, fiber casting, pressing, extruding, and/or foaming. As one particular nonlimiting example, a conventional pressing technique, such as the one generally described above, and illustrated in FIGS. 1-2, can be utilized.

Regardless of the particular technique used for forming, according to certain aspects of the present invention, the forming can be carried out with the aid of one or more supports, such as support (40) of FIGS. 1-2. The support can aid in the formation of the green bodies in a number of possible respects. For example, the flowable mixture can be compressed against a surface of the support in order to facilitate a molding process. However, the particular role of the support in the forming process is not so limited. Thus, the support can be used as a separate member apart from an actual pressing technique, whereby after the green bodies have already been formed by separate members, the as-formed green bodies can then be placed onto a surface of the support. A number of different possible uses of a support in the forming process are also possible, and comprehended by the principles of the present invention.

According to certain optional aspects of the present invention, the supports can be in the form of what is referred to in the art is a pressing board. Such pressing boards can be formed from a number of different materials, so long as they provide the desired degree of rigidity for supporting one or more green bodies on a surface thereof. Suitable materials include plastics, metals and composites. According to one nonlimiting example of the present invention, the support can be formed, at least in part, from a metallic substance. It is envisioned that the support can be formed entirely from a metal alloy, or maybe in the form of a composite that includes a metallic component therein. Regardless, according to this nonlimiting embodiment, the support can be made electrically conductive. This feature has the advantage of allowing heating and efficient transfer of thermal energy to the green bodies in subsequent curing steps. According to certain aspects, the metallic support can be heated through electrical resistance heating techniques in order to increase the temperature of the green bodies disposed on a surface thereof.

### Pre-Curing of the One or More Green Body

According to certain aspects of the present invention, the one or more green body is optionally subjected to a partial or pre-curing process. The main criteria for designing an appropriate partial or pre-curing procedure is to provide the one or more green body with sufficient strength such that it can be removed from the one or more supports, and remain substantially intact. As a further optional objective or criteria for designing an appropriate partial or pre-curing procedure, is to provide the one or more green body with sufficient strength to withstand the weight of several additional green bodies to be stacked on top of it, such as the case for a bottom row of a palleted cube of green bodies formed for final curing, as described further herein.

As alluded to previously, the ability to remove the green bodies from their supports prior to the completion of curing provides a number of benefits and advantages. First, the supports, or pressing boards, can be returned more quickly for use in the upstream pressing operations, thereby resulting in increased efficiency in that fewer pressing boards will need to be kept on hand in order to ensure the same volume of output. Second, carbonatable cement/concrete formulations of the present invention benefit from maximum exposure to a gaseous reactant (e.g., carbon dioxide), as well as a controlled loss of moisture. Having a major surface of the green body in contact with a surface of the support or pressing board impedes both the flow of a gaseous reactant into the green body, and the release of moisture therefrom. Therefore, removing the green bodies from the supports or pressing boards can enhance and improve the efficiency of further curing operations. Third, the early removal of the green bodies from their supports, permit their assembly into a collection having a predetermined geometrical configuration. This collection can take the form of a tightly stacked cube or other geometrical configuration. Subjecting such a tightly stacked cube or other form to further curing operations can be advantageous relative to curing the green bodies being relatively loosely placed on supports, in terms of moisture retention/loss behavior, and heat retention of the green bodies during further curing operations. Fourth, the early removal of the green bodies from their supports allow them to be assembled in a configuration that is suitable for shipping, once final curing has been completed, thus eliminating the need for a downstream material handling step.

The strength of the partially or pre-cured green bodies can be characterized by any appropriate measure, such as tensile strength, compressive strength, or both. By way of nonlimiting example, the one or more green body can be partially or pre-cured to a compressive strength of about 2,000 to about 5,000 psi, or about 2,400 to about 4,500 psi, as measured by using the ASTM C140 standard. A minimum strength of at least about 2,000 psi is advantageous for providing the green body with sufficient strength in order to permit handling, while remaining substantially intact. On the other hand, partially or pre-curing the green bodies to achieve compressive strengths that are much beyond 5,000 psi can prove disadvantageous in terms of depleting the amount of water contained within the green body, which can inhibit additional curing operations and limit the ultimate compressive strength of a cured body (e.g., at least about 8,000 psi).

According to certain optional aspects, partially or pre-curing the green bodies involves introducing the green bodies and the one or more support into a pre-curing chamber, and in the case of green bodies formed from a carbonatable cement/concrete composition, exposing the green bodies and their supports to an atmosphere containing carbon dioxide, air, or a combination thereof, for a predetermined period of time. The specific conditions used in the chamber can vary based upon the design of the chamber itself, the chemical nature of the constituents forming the cement/concrete composition of the green bodies, the desired degree of pre-cured strength, etc. Generally speaking, according to certain nonlimiting examples, the partial or pre-curing procedure can be conducted under one or more of the following environmental conditions: about 4° C. to about 200° C., about 50° C. to about 130° C., or about 60° C. to about 85° C.; curing time of about 60 minutes to about 600 minutes, about 60 to about 360 minutes, about 60 to about 300 minutes, 60 to about 240 minutes, 60 to about 180 minutes, 60 to about 120 minutes, or 60 to about 90 minutes; a pressure of about 0.01 psi to about 0.04 psi, a relative humidity of about 1% to about 80%; and a CO₂ concentration of about 1% to about 99%.

According to one additional nonlimiting embodiment, the supports (40) can be made from a conductive material, such as metal, and the supports can be heated through a suitable technique, such as electrical resistance heating. This optional heating of the supports may take place throughout the entire pre-curing time. During which the green bodies are subjected to pre-curing, or the supports can be heated for only a portion of the overall pre-curing time, such as during an initial ramp-up period (e.g., first 1 hour of pre-curing). According to this optional embodiment, the ability to raise the temperature of the green bodies (10) is enhanced by heating the supports (40) in contact therewith.

Additional optional and non-limiting partial or pre-curing process specifications for the one or more green body and its support(s) may include one or more of:

(1) Carbon dioxide flow rate into the pre-curing chamber: about 1 to about 250 liters-per-minute (LPM), about 10 to about 125 LPM, or about 40 to about 80 LPM;

(2) CO₂ gas inlet temperature of the pre-curing chamber: about 4° C. to about 225° C., or about 90° C. to about 100° C.;

(3) Pre-curing chamber continuous operation temperature: about 4° C. to about 200° C., about 50° C. to about 130° C., or about 60° C. to about 85° C.;

(4) Pre-curing chamber pressure: about 0.05 to about 1.0 inches of water, about 0.3 to about 0.7 inches of water, or about 0.4 to about 0.5 inches of water;

(5) Time to reach 50° C. in the pre-curing chamber: up to about 1 h, or about 20 minutes or less;

(6) Time to reach 70° C. in the pre-curing chamber: up to about 3 h, or about 90 minutes or less;

(7) Time to reach 30 to 40% relative humidity (RH) in the pre-curing chamber: up to about 1 h, or about 30 minutes or less;

(8) Time to reach 10% RH in the pre-curing chamber: up to about 90 minutes, or about 60 minutes or less;

(9) Time to reach 5% RH in the pre-curing chamber: up to about 2.5 hrs., or about 2 hrs. or less;

(10) Residual water (remaining in the pavers at the end of the partial or pre-curing process) by weight percentage of the mass of an individual paver: about 0.5% to about 3%, about 1% to about 2.5%, or about 1.2% to about 1.6%; and

(11) Compressive strength (measured by using the ASTM C140 standard) of pavers at the end of partial or pre-curing process: about 1,500 to about 8,000 psi, about 2,000 to about 5,000 psi, or about 2,500 to about 3,500 psi.

The particular configuration of the partial or pre-curing chamber itself is not particularly limited, so long as it is capable of providing the appropriate partial or pre-curing conditions for the green bodies and their supports.

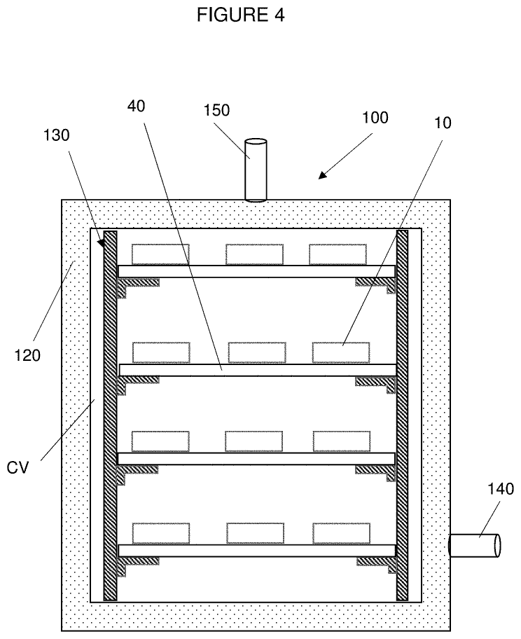

According to one illustrative and nonlimiting example, a partial or pre-curing arrangement (100) can be provided with the components and configuration schematically and generally illustrated in FIG. 4. As illustrated therein, the partial or pre-curing arrangement (100) may include a pre-curing chamber (120). The pre-curing chamber (120) can be provided with any suitable shape or size, and can be formed from any suitable material. According to certain nonlimiting examples, the pre-curing chamber (120) can be formed from a rigid material, such as a metal, ceramic, or plastic material. Optionally, the pre-curing chamber (120) can be formed from a metallic material, such as aluminum. According to further optional aspects, the pre-curing chamber can be formed from a material that possesses insulative properties in order to improve the retention of heat therein. Alternatively, the pre-curing chamber can be formed from a metallic material, such as aluminum, and further provided with a separate insulative material. According to a further optional embodiment, the pre-curing chamber (120) can be formed from a flexible material. The flexible material can take any suitable form, but preferably has some degree of heat resistance, and at least resists permeation of the material by the gaseous reactants contained within the interior portion of the pre-curing chamber (120). According to one nonlimiting example, a flexible pre-curing chamber (120) can be formed from a woven material coated with a polymer. The pre-curing chamber (120), however formed, possesses a hollow interior having a predetermined interior chamber volume, as indicated at CV in FIG. 4.

As further illustrated in FIG. 4, the green bodies (10) along with their supports (40) are placed into the interior of the pre-curing chamber (120), and a door or closure (not shown) is used to seal the green bodies (10) and their supports (40) within the pre-curing chamber in a manner that permits control of the environmental conditions within the pre-curing chamber. Exemplary pre-curing chamber conditions are detailed above. According to certain aspects, a support system (130), such as racks/shelving, may optionally be provided within the pre-curing chamber (120) in order to support and position the green bodies (10) and their supports (40) during the partial or pre-curing process.

The pre-curing chamber (120) can be further provided with a suitable gas circulation system for furnishing a gaseous environment to the interior of the pre-curing chamber. When used to partially or pre-cure a carbonatable cement/concrete composition, the arrangement (120) includes appropriate components for introducing CO₂ into the interior of the pre-curing chamber. Such components may include a gas inlet (140) and a gas outlet (150), as further illustrated in FIG. 4. It should be understood that both the location and number of the gas inlet (140) and/or the gas outlet (150) can be varied depending on the size of the pre-curing chamber, desired flow rates, etc. According to certain nonlimiting examples, the pre-curing chamber (120) has 1-16, 1-12, 1-8, or 1-4 gas inlets (140). According to further illustrative embodiments, the inlets (140) can be positioned in any suitable manner. For example, one or more of the inlets (140) can be positioned at a location that is proximate to the bottom of the pre-curing chamber (120). This position can be advantageous because the gas is introduced through the inlet (140) can be heated. As the heated gas enters the interior of the pre-curing chamber (120) it has the tendency to rise vertically toward the top of the pre-curing chamber, and thus propagate naturally over the green bodies (10) located within the pre-curing chamber. The heated gas will naturally migrate toward one or more gas outlets (150) which can optionally be provided at a location proximate the top of the pre-curing chamber (120).

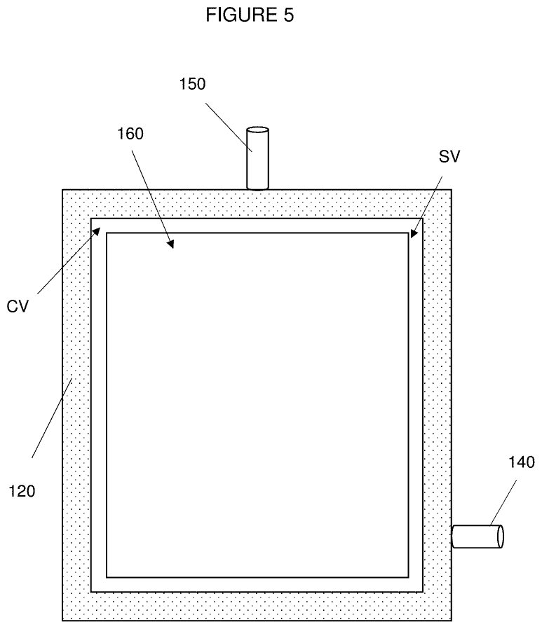

According to a further optional embodiment, as illustrated in FIG. 5, the pre-curing chamber (120) and the objects loaded therein for partial or pre-curing can be designed such that the interior volume (CV) of the pre-curing chamber (120) is only slightly larger than the total volume of the green bodies and their supports (SV) loaded therein, as schematically illustrated at (160). Thus, for example, the pre-curing chamber (120) can be designed such that it has an interior chamber volume (CV) to green body/support volume (SV) ratio of about 1.05 to about 1.15. Providing the pre-curing chamber (120) with this design allows for the more efficient control of the environmental conditions contained therein. This, in turn provides the ability to reach optimal curing conditions in a more rapid fashion, and complete the overall partial or pre-curing process in a shorter period of time when compared with chambers that have a less efficient design.

Once the partial or pre-curing process has been completed, the green bodies (10) and their supports (40) are removed from the pre-curing chamber, and the green bodies (10) removed from their supports (40). The green bodies (10) can be removed from their supports (40) either manually, or with the assistance of any suitable device or apparatus. According to certain nonlimiting examples, green bodies (10) can be removed from their supports (40) with the aid of a conventional palletizer machine (not shown), and the green bodies (10) arranged in a predetermined geometrical configuration, such as a cube. This example is of course illustrative, as any number of suitable geometries are possible, with or without the aid of a mechanical device or apparatus. Suitable geometric configurations formed by the freed green bodies (10) can include one or more of: a cube, a pyramid, a cone, a three-dimensional frustoconical shape, a cylinder, a three-dimensional pentagon, a three-dimensional hexagon, a three-dimensional heptagon, a three-dimensional octagon, or a three-dimensional nonagon. According to certain optional aspects, the number of green bodies (10) recovered from a single partial or pre-curing process is sufficient to form one or more of the above-mentioned geometrical configurations. Alternatively, green bodies (10) can be recovered from multiple partial or pre-curing batch operations, collected, and used to form one or more of the above-mentioned geometrical configurations. It is envisioned, that within the principles of the present invention, any suitable number of partially or pre-cured green bodies (10) can be collected and used to form one or more of the above-mentioned geometrical configurations. According to illustrative and nonlimiting examples, 480 or more, or 540 or more, green bodies can be assembled to form the above-mentioned geometrical configuration, which is then subjected to further curing operations, as a unitary structure. According to further optional and nonlimiting aspects, the green bodies can be pavers, and the collection of green bodies can form a paver cube.

### Curing Chamber and Process Specifications

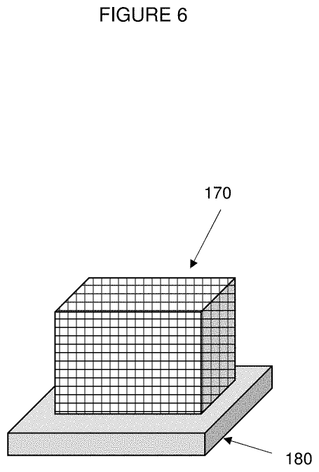

The collection of a plurality of pre-cured green bodies assembled into one or more of the above-mentioned geometric configurations can then be further cured, together as one or more unified structure(s). One such collection (170) is schematically illustrated in FIG. 6 in the form of a three-dimensional cube disposed on an optional platform (180), such as a pallet. As previously mentioned, any suitable number of pre-cured green bodies can be used to form such a configuration. Nonlimiting examples include 480 or more pre-cured green bodies, or 540 or more pre-cured green bodies.

The main criteria for designing an appropriate curing procedure is that it provides the pre-cured green bodies with adequate strength characteristics upon completion of the curing stage. The strength of the cured bodies can be characterized by any appropriate measure, such as tensile strength, compressive strength, or both. By way of nonlimiting example, the one or more cured body can be cured to a compressive strength of about 8,000 to about 17,000 psi, about 9,000 to 15,000 psi, or at least about 9,200 psi, as measured by using the ASTM C140 standard. A minimum strength of at least about 8,000 psi is advantageous for providing the cured body with sufficient strength in order to meet certain industry standards applicable to a particular application of the cured body, such as pavers, slabs, and the like. Curing to such a degree that provides strength values that greatly exceed accepted standard minimum strength is uneconomical and unnecessary.

According to certain optional aspects, curing the green bodies having a particular geometrical configuration involves introducing the collection (170), optionally disposed upon a platform (180), into a curing chamber, and in the case of pre-cured green bodies formed from a carbonatable cement/concrete composition, exposing the green bodies to an atmosphere containing carbon dioxide, air, or a combination thereof, for a predetermined period of time. The specific conditions used in the chamber can vary based upon the design of the chamber itself, the chemical nature of the constituents forming the cement/concrete composition of the green bodies, the desired degree of strength, etc. Generally speaking, according to certain nonlimiting examples, the curing procedure can be conducted under one or more of the following environmental conditions: about 4° C. to about 200° C., about 50° C. to about 130° C., about 60° C. to about 95° C., or about 88° C. to about 95° C.; curing time of about 6 to about 24 hrs.; a pressure of about 0.01 psi to about 0.04 psi, a relative humidity of about 1% to about 80%, and a CO₂ concentration of about 1% to about 99%.

Additional optional and non-limiting curing process specifications for the production of cured bodies may include one or more of:

(1) Carbon dioxide flow rate into the curing chamber: about 1 to about 250 liters-per-minute (LPM), about 10 to about 125 LPM, or about 50 to about 80 LPM;

(2) CO₂ gas inlet temperature of the curing chamber: about 4° C. to 225° C., about 90° C. to about 40° C., or about 110° C. to about 120° C.;

(3) Curing chamber continuous operation temperature: about 4° C. to about 200° C., about 50° C. to about 130° C., or about 88° C. to about 95° C.;

(4) Curing chamber pressure: about 0.05 to about 1.0 inches of water, about 0.3 to about 0.7 inches of water, or about 0.5 inches of water;

(5) Time to reach 50° C. in the curing chamber: up to about 2 hrs., or about 60 minutes or less;

(6) Time to reach 75° C. in the curing chamber: up to about 5 hrs., or about 150 minutes or less;

(7) Time to reach 95° C. in the curing chamber: up to about 10 hrs., or about 4 hrs. or less;

(8) Time to reach 30 to 40% relative humidity (RH) in the curing chamber: up to about 4 hrs., or about 30 minutes or less;

(9) Time to reach 10% RH in the curing chamber: up to about 6 hrs., or about 100 minutes or less;

(10) Time to reach 5% RH in the curing chamber: up to about 2.5 h, or about 2 hrs. or less;

(11) Residual water (remaining in the pavers or concrete at the end of the curing process) by weight percentage of the mass of an individual paver: about 0.1% to about 2%, about 0.3% to about 1.5%, or about 0.2% to about 0.9%; and

(12) Compressive strength (measured by using the ASTM C140 standard) of the bodies at the end of curing process: about 8,000 to about 17,000 psi, or about 9,000 to about 15,000 psi.

Curing a collection of bodies together as a unitary structure (e.g., 170) provides certain benefits and advantages not readily attainable by conventional curing methods that typically conduct the entire curing operation on the green bodies while disposed on a surface of a support or pressing board (e.g., 10, 40). Such advantages include, but are not limited to: (1) the temperature profile of the unitary structure is more homogenous when compared with the interior of the chamber loaded with green bodies stacked on supports, wherein the supports act like physical separators and insulators between different layers of green bodies; (2) the relative humidity profile of the unitary structure is more homogenous when compared with the interior of the chamber loaded with green bodies stacked on supports, wherein the supports and green bodies disposed thereon are more prone to be affected by changes in gas flow patterns from level to level, and within different areas of the interior of the chamber; (3) water vapor distribution within the unitary structure as a whole tends to be more homogenous and resistant to over drying the exterior surfaces and areas of the green bodies, when compared with green bodies stacked on supports; and (4) closely packing the green bodies to form a unitary structure having a particular geometrical configuration facilitates the minimization of the difference between the interior chamber volume (CV) and the volume of the collection of green bodies (SV), which provides greater efficiencies and controlling the environment of the interior of the chamber.

The particular configuration of the curing chamber itself is not particularly limited, so long as it is capable of providing the appropriate curing conditions for the collection of green bodies. According to one optional aspect, curing can be performed in the same chamber as the pre-curing process. Thus, the curing chamber can possess the same design and features as the pre-curing chamber, as previously described, and the previous description thereof is incorporated herein by reference. For instance, the curing chamber can have the same features, and be formed from the same materials, as the exemplary chamber schematically illustrated in FIG. 4. To the degree necessary to accommodate the collection of green bodies (e.g., 170) the support system or shelving (130) used to accommodate the supports (40) can be omitted or removed from the interior of the chamber (120). Moreover, as previously discussed above, the curing chamber can be designed this such that its interior volume (CV) is only slightly larger than the volume of the collection of green bodies (SV). In this regard, referring to FIG. 5, element (120) can refer to the curing chamber, and element (160) can schematically represent the collection of green bodies (170) and any optional platform (180). According to certain nonlimiting embodiments, the ratio of the interior volume of the curing chamber (120) to the volume of the collection of green bodies, or CV/SV, is about 1.05 to about 1.15. As previously explained, minimizing this ratio allows for better and more efficient control of the environmental conditions within the curing chamber (120).

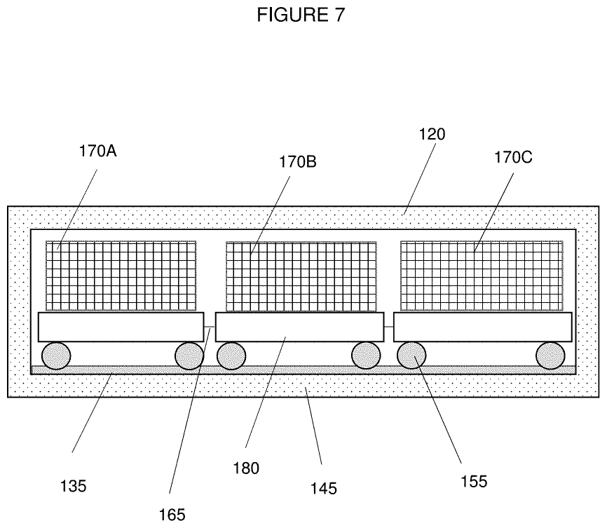

As schematically illustrated in FIG. 7, according to certain alternative embodiments, the chamber (120) can be scaled up, or designed with sufficient volume to accommodate a plurality of the collections of the green bodies (170A, 170B, 170C). Each of the plurality of the collections of the green bodies (170A-C) can be provided with a structure to render it movable within the chamber (120). Any suitable mechanism can be provided for this purpose. According to one nonlimiting example, rails (135) can be provided along the floor (145) of the chamber (120), and the platforms (180) provided with wheels (155) that cooperate with the rails (135) so that the platforms (180), and its collection of green bodies (170) can move along the rails (135) within the chamber (120) from one end of the chamber to another. Ideally, adjacent platforms (180)/collections of green bodies (170) are closely spaced, and optionally connected together (165), like railcars of a train. This close spacing advantageously minimizes the difference between the interior chamber volume (CV) and the total sample volume of the platforms (180)/collections of green bodies (170) (SV).

According to certain optional nonlimiting embodiments, curing can be performed in a separate chamber than was used for the partial or pre-curing stage. Certain optional additional curing chamber designs and operating conditions according to further aspects of the present invention will now be described.

### Vertical Bottom-Up Flow Chamber (VBUF) and Curing Process Specifications

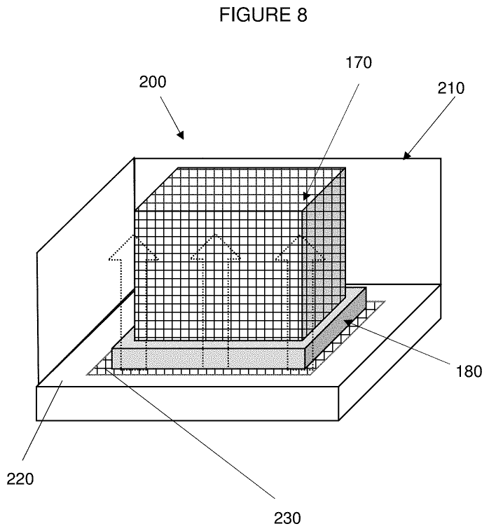

As previously described, and illustrated in FIG. 4, one or more gas inlets (140) can be provided in the side(s) of the chamber. Alternatively, the curing chamber is designed such that it has a permeable member in the bottom or floor of the chamber which allows a heated gaseous reactant (e.g., containing CO₂ gas) to enter the collection of green bodies from its bottom, and the heated gaseous reactant permeates upwards through the pores of green bodies. A nonlimiting example of such an arrangement is illustrated in FIG. 8. As shown therein, the arrangement (200) includes a chamber (210), shown in a partial exploded view, that includes a floor or bottom surface (220). A permeable member (230) is provided in the floor or bottom surface (220) of the chamber (210). The permeable member (230) can be formed from any suitable material and take any suitable form. According to one nonlimiting example, the permeable member (230) is in the form of a steel grate. As illustrated in FIG. 8, a gaseous reactant, such as gaseous CO₂, or a mixture of air or another gas and CO₂, is introduced through the permeable member (230), and migrates upwardly through the platform (180) and through the collection of green bodies (170) as indicated by the arrows contained in FIG. 8. As the heated gas flows upward, its cools down a bit while it is permeating through the collection of green bodies, thus a thermal gradient in situ is created, so that the chemical reactant gas flows across that thermal gradient from hotter areas (i.e., bottom) to the upper cooler zones. Rapid heating modes are thus attainable within the chamber (210). The chamber (210) can include one or more gas outlet(s) at its top (e.g., FIG. 4, (150)).

The chamber (210) can also be designed to have only a slightly larger interior volume (CV) than the volume of the collection of green bodies (170) and its support (180) disposed therein (SV). This relationship is schematically illustrated in FIG. 5. Thus, according to this embodiment, the curing chamber interior volume (CV) to sample volume (SV) ratio (CV/SV) is preferably about 1.05 to about 1.15. Minimizing this ratio allows for the efficient control of the environmental conditions within the chamber (210).

According to a further optional embodiment, the VBUF chamber (210) can also be scaled up in size such that it can accommodate a plurality of collections of green bodies (170) and their optional platforms (180). According to this optional embodiment, the plurality of collections of green bodies (170) and their optional platforms are preferably tightly arranged and closely spaced in order to minimize the CV/SV ratio. For example, the CV/SP ratio in such an arrangement is within the previously described range of about 1.05 to about 1.15.

According to an additional optional embodiment, the arrangement depicted in FIG. 7 can be modified utilizing the VBUF concept, by forming the floor (145) of the chamber (120) with a large permeable member (230), such as a steel grate. Alternatively, the floor (145) could be modified by locating a plurality of spaced apart permeable members (230) therein. These modifications provide the arrangement depicted in FIG. 7 with the added benefits of the previously described vertical bottom upwardly flow of a gaseous reactant which facilitates curing of the green bodies.

Additional optional and non-limiting VBUF curing chamber process specifications for the production of cured bodies may include one or more of:

(1) Carbon dioxide flow rate into the VBUF curing chamber: about 1 to about 250 liters-per-minute (LPM), about 10 to about 125 LPM, or about 50 to about 80 LPM;

(2) CO₂ gas inlet temperature of the VBUF curing chamber: about 4° C. to about 250° C., about 90° C. to 200° C., or about 140° C. to 150° C. (the gas inlet temperature for VBUF means the gas temperature at the bottom surface of the platform (180)/collection of green bodies (170) which is sitting on the permeable member (230);

(3) VBUF chamber continuous operation temperature: about 4° C. to about 200° C., about 50° C. to 120° C., or about 80° C. to about 98° C.;

(4) VBUF chamber pressure: about 0.05 to about 1.0 inches of water, or about 0.3 to about 0.7 inches of water, or 0.5 inches of water;

(5) Time to reach 50° C. in the VBUF chamber: up to about 20 minutes, or about 10 minutes or less;

(6) Time to reach 75° C. in the VBUF chamber: up to about 1 hr., or about 30 minutes or less;

(7) Time to reach 90° C. in the VBUF chamber: up to about 2 hrs., or about 1 hr. or less;

(8) Time to reach 30 to 40% relative humidity (RH) in the VBUF chamber: up to about 1 hr., or about 30 minutes or less;

(9) Time to reach 10% RH in the VBUF chamber: up to about 90 minutes, or about 30 minutes or less; and

(10) Time to reach 5% RH in the VBUF chamber: up to about 2.5 hrs., or about 1 hr. or less.

### Continuous Curing Vertical Bottom Up Flow (CC-VBUF) Chamber and Curing Process Specifications

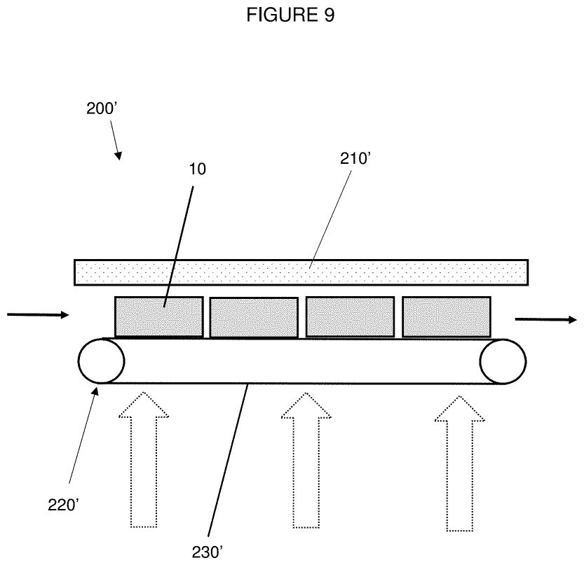

Further modifications of the above-mentioned VBUF chamber design are also contemplated by the present invention. One such modified VBUF arrangement (200′) is illustrated in FIG. 9. As illustrated therein, a modified VBUF chamber (210′) is provided with a modified chamber floor (220′) and a modified permeable member (230′). According to certain optional aspects, a moving conveyor, with a load-bearing grate or grille (230′) as its pre-cured green body (10) holder surface, defines the bottom of the CC-VBUF chamber. The movement of the conveyor can be continuous or intermittent. Pre-cured green bodies (10) are placed on the grate/grille (230′) as a single layer. Thus, unlike previous embodiments described herein, after the green bodies have been subjected to a pre-curing process, they are removed from their supports (40) but not collected or assembled into any particular configuration for additional curing as a unitary structure. Rather, they are placed on the conveyor (230′) in the form of a closely spaced single-layer for further curing in the CC-VBUF. This configuration of a single layer of pre-cured green bodies (10) in the CC-VBUF chamber allows CO₂-curing to be completed in significantly less time. By way of nonlimiting example, curing of the pre-cured green bodies (10) can be completed in 6 hours, or less. The preferred CV-to-SV ratio of the CC-VBUF chamber is similar to that of the VBUF chamber (i.e., CV/SV=about 1.05−about 1.15).

The pre-cured green bodies to be cured enter from one side of the CC-VBUF chamber and the conveyor moves them in the direction of the horizontal arrows appearing in FIG. 9 ,to deliver the cured bodies to the other side of the chamber. According to certain optional aspects, the cured bodies can then be collected by a suitable apparatus, and prepared for shipping. According to one nonlimiting example, the cured bodies can be collected by a palletizer and stacked to form a geometrical configuration, such as a cube. The geometrical configuration (170) can be formed on a support (180) to facilitate shipping.

A chemical reactant gas (e.g., CO₂, or a mixture of air and/or another gas and CO₂) is introduced from the bottom of the grate or grille, identical in principle to the design and operation of the VBUF chamber, as indicated by the vertical arrows appearing in FIG. 9. The speed at which the conveyor belt (230′) moves can be used to determine the total curing time and therefore the total residence time of bodies in the CC-VBUF chamber (210′). Alternatively, the conveyor (220′) can advance the bodies (10) to a location within the chamber (210′), stop for a predetermined amount of time, then be restarted to cause the bodies (10) to exit the chamber (210′). Temperature is kept uniform throughout the majority of the chamber volume, with the instantaneous and brief exception of the sample entry and exit locations at each side of the CC-VBUF chamber (210′). The minimization of the CV/SV ratio (e.g., CV/SV =about 1.05 to about 1.15) facilitates the maintenance of uniform temperature and relative humidity distributions in the chamber (210′). The carbon dioxide flow rates, temperature and RH specifications of the CC-VBUF chamber (210′) are similar to, or the same as, those specified above for the VBUF chamber (210).

According to an additional optional embodiment, the arrangement depicted in FIG. 7 can be modified utilizing the above-described CC-VBUF concept, by forming the floor (145) of the chamber (120) as a movable conveyor (220′). In other words, the rails (135) and wheels (155) can be replaced by a movable conveyor (220′) having a permeable belt (230′). This modification provides the arrangement depicted in FIG. 7 with the added benefits of the above-described vertical bottom upwardly flow of a gaseous reactant which facilitates curing of the green bodies.

Subsequent to the completion of the main curing phase, regardless of the particular conditions, chamber design, or techniques used, the cured bodies are prepared for shipping, or “caused to be shipped” to a customer. This particular phase of the process is intended to encompass a broad range of actions typical in the manufacture of cured green bodies. For example, the cured objects can simply be moved to a particular location of a facility for the ultimate removal of the cured bodies from the facility in which they are made for transport to a customer. According to another nonlimiting example, a notification may be sent to a third-party that initiates the process for retrieval and transportation of the cured bodies to a customer. Such notifications are intended to be comprehended by this step. “Causing the collection of cured bodies to be shipped to a customer” in no way implies that actual shipping or transportation of the cured bodies is involved in this step.

In view of the above, it will be seen that the several advantages of the invention are achieved and other advantages attained.

As various changes could be made in the above methods and compositions without departing from the scope of the invention, it is intended that all matter contained in the above description shall be interpreted as illustrative and not in a limiting sense. It is envisioned that the present invention encompasses any possible combination of the following claims, regardless of their currently-stated dependencies.

Any numbers expressing quantities of ingredients, constituents, reaction conditions, and so forth used in the specification are to be interpreted as encompassing the exact numerical values identified herein, as well as being modified in all instances by the term “about.” Notwithstanding that the numerical ranges and parameters setting forth, the broad scope of the subject matter presented herein are approximations, the numerical values set forth are indicated as precisely as possible. Any numerical value, however, may inherently contain certain errors or inaccuracies as evident from the standard deviation found in their respective measurement techniques. None of the features recited herein should be interpreted as invoking 35 U.S.C. § 112, paragraph 6, unless the term “means” is explicitly used.

We claim:

1. A method of forming a plurality of cured concrete bodies, each body possessing a cured compressive strength, the method comprising:
introducing a flowable mixture of constituent components of the concrete into a plurality of molds;
molding the flowable mixture within the plurality of molds with the aid of one or more support, thereby forming a plurality of green bodies;
partially curing the green bodies to a degree sufficient to provide a compressive strength that is lower than the cured compressive strength, thereby producing a plurality of pre-cured green bodies;
assembling at least a portion of the plurality of pre-cured green bodies to form a collection thereof having a predetermined geometrical configuration; and
curing the collection of pre-cured green bodies to a 1e sufficient to achieve the cured compressive strength, thereby producing a collection of cured bodies having the predetermined geometrical configuration.

2. The method of claim 1, further comprising:
causing the collection of cured bodies having the predetermined geometrical configuration to be shipped to a customer.

3. The method of claim 1, wherein the constituent components comprise one or more carbonatable cement component and one or more aggregate.

4. The method of claim 1, wherein the one or more carbonatable cement component comprises calcium silicate.

5. The method of claim 4, wherein the flowable mixture comprises water.

6. The method of claim 1, wherein at least one of the steps of introducing and molding comprises one or more of: pouring, vibrocasting, pressing, extruding, or foaming.

7. The method of claim 1, wherein the one or more support is a pressing board.

8. The method of claim 1, wherein the one or more support is metallic.

9. The method of claim 1, wherein the plurality of green bodies comprise pavers, concrete blocks, roof tiles, hollow core slabs, wet cast slabs, concrete slabs, foamed concrete bodies, aerated concrete bodies, aerated concrete masonry units, or aerated concrete panels.

10. The method of claim 1, where in the compressive strength of the pre-cured green bodies is sufficient to permit removal of the green bodies from the support, while the green bodies remain substantially intact.

11. The method of claim 1, wherein the compressive strength of the pre-cured green bodies is about 2,000 psi to about 5,000 psi, as measured according to ASTM C140.

12. The method of claim 1, wherein the cured compressive strength is at least about 8,000 psi, as measured according to ASTM C140.

13. The method of claim 1, wherein the step of partially curing the green bodies comprises introducing the green bodies and the one or more support into a pre-curing chamber.

14. The method of claim 1, wherein the step of partially curing the green bodies comprises exposing the green bodies and the one or more support to carbon dioxide, air, or a combination thereof, for a predetermined period of time.

15. The method of claim 1, wherein the step of partially curing the green bodies comprises exposing the green bodies to carbon dioxide for a period of time of about 60 to about 600 minutes, and a temperature of about 50° C. to about 120° C.

16. The method of claim 8, wherein the step of partially curing the green bodies further comprising heating the at least one metallic support.

17. The method of claim 16, wherein the heating of the at least one metallic support comprises electrical resistance heating.

18. The method of claim 1, wherein the step of assembling the plurality of pre-cured green bodies comprising removing the pre-cured green bodies from a surface of the one or more support.

19. The method of claim 18, wherein the pre-cured green bodies are removed from the one or more support using a palletizer machine or a material handling system.

20. The method of claim 1, wherein the predetermined geometrical configuration is a cube.

21. The method of claim 18, wherein the cube comprises about 480 pre-cured green bodies, or more.

22. The method of claim 1, wherein the step of curing the pre-cured green bodies comprises introducing the collection of pre-cured green bodies into a curing chamber.

23. The method of claim 1, wherein the step of curing the pre-cured green bodies comprises exposing the pre-cured green bodies to carbon dioxide for a period of time of about 6 to about 24 hours, and a temperature of about 60° C. to about 95° C.

24. The method of claim 22, wherein the step of partially curing the green bodies, or the step of curing the pre-cured green bodies, further comprising introducing heated gas into the pre-curing or curing chamber from a location disposed proximate to the bottom of the pre-curing or curing chamber.

25. The method of claim 22, wherein the step of partially curing the green bodies, or the step of curing the pre-cured green bodies, further comprising withdrawing the heated gas from the pre-curing or curing chamber from a location disposed proximate to the top of the pre-curing or curing chamber.

26. The method of claim 22, wherein the step of curing the pre-cured green bodies further comprises placing the collection of pre-cured green bodies onto a moveable platform for moving the collection of pre-cured green bodies from one end of the curing chamber to an opposite end.

27. The method of claim 13, wherein the green bodies and their supports have a sample volume, and the pre-curing chamber has an interior volume, and wherein a ratio of the interior volume of the pre-curing chamber to the sample volume is about 1.05 to about 1.15.

28. The method of claim 22, wherein the collection of pre-cured green bodies having the predetermined geometrical configuration has a sample volume, and the curing chamber has an interior volume, and wherein a ratio of the interior volume of the curing chamber to the sample volume is about 1.05 to about 1.15.
